(19) United States
(12) Patent Application Publication
(10) Pub. No.: US 2025/0253560 A1
(43) Pub. Date: Aug. 7, 2025

(54) MODULAR BATTERY CHARGER

(71) Applicant: Datalogic IP Tech S.R.L., Lippo Di Calderara Di Reno (Bologna) (IT)

(72) Inventors: Giuseppe DI BARI, Bologna (IT); Manlio GALANTI, Bologna (IT); Entony BETTARELLI, Bologna (IT); Stefano PISTIS, Bologna (IT); Davide GAVIOLI, Bologna (IT); Andrea SAVARESE, Bologna (IT)

(21) Appl. No.: 18/432,403

(22) Filed: Feb. 5, 2024

(51) Int. Cl. H01R 12/71; H01R 13/514; H02J 7/00

(52) U.S. Cl. CPC H01R 12/714; H01R 13/514; H02J 7/0013

(57) ABSTRACT

A multi-battery charger that includes identical slot charging modules or chargers that can connect together based on a desired number of charging modules to be used. The slot chargers may be configured with identical male and female interfaces to allow the slot chargers to be electrically and mechanically connected together in a matrix configuration or a serial configuration, depending on implementation of a full modularity or partial modularity. The slot chargers can be held together using magnets and/or simple mechanical interfaces for easy addition or removal from the group.

### BACKGROUND

Currently, there exists multiple charger models, which come in a fixed number of slots, such as a single slot, 10-slot, or N-slot version. This means that one can only purchase a charger with a fixed number of slots, leading to low modularity or no modularity in terms of being able to customize to a desired number of slots. Consequently, a purchaser may have to buy a charger with excess capacity when such charger is not needed. A user has to determine charging needs and decide if it is advantageous to purchase and use several single slot chargers, each with its own power source. Or, the user must buy a N-slot charger with slots that may go unused. In another situation, a technician may create a charger with a fixed number of slots. If the user needs more slots, the user has to contact the technician who has to intervene and add more slots to the charger, usually with additional tools like screws for the fixing.

A solution is needed where the user is not forced to buy a one-slot charger or a N-slot charger, but have a flexibility to buy an intermediate number of slots for charging as well as have the ability of adding slots later. The solution is needed where the user may change the number of slots without requiring the intervention of a technician or other person.

### SUMMARY

This summary is provided to introduce a selection of concepts in a simplified form that are further described below in the detailed description section of this disclosure. This summary is not intended to identify key or essential features of the claimed subject matter, nor is it intended to be used as an aid in determining the scope of the claimed subject matter.

Embodiments of the present disclosure propose the making of a charging device with a single slot with a design that allows connection of other single slot charging devices. The connection of multiple slot charging devices together forms a multi-device charging station or multi-station charger or modular charging station or multi-battery charger. These names will be used interchangeably throughout this disclosure. The modular charger allows an end user to independently create a multi-station charger by joining several single charging devices (i.e., charging modules) to form a desired slot number. This flexibility in having a desired number of slots allows economies of scale. In some embodiments, the creation of the modular charging devices (including slots) uses one plastic kit and one PCB for each charging device. A user has maximum flexibility in choosing the number of slots best suited for their needs together with the possibility of subsequently increasing the number of slots by adding additional charging devices to the modular charging station.

### BRIEF DESCRIPTION OF THE DRAWINGS

An apparatus and method are described in detail below with reference to the attached drawing figures, wherein:

FIG. 1 illustrates an exploded view of a single-slot charger that connects to other chargers, in accordance with an embodiment of the present disclosure;

FIG. 2 illustrates an isometric view of a multi-battery charger, in accordance with an embodiment of the present disclosure;

FIG. 3 illustrates a top view of a multi-battery charger with a set of single-slot chargers arranged to connect together, in accordance with an embodiment of the present disclosure;

FIG. 4 illustrates a multi-battery charges with single-slot chargers connected serially, in accordance with an embodiment of the present disclosure;

FIG. 5 illustrates a top view of a multi-battery charger with serially connected single-slot chargers, in accordance with an embodiment of the present disclosure;

FIG. 6 illustrates a method of making a multi-device charging station, in accordance with an embodiment of the present disclosure;

FIG. 7 shows a battery charger for a battery and/or battery powered device according to another embodiment of the disclosure;

FIGS. 8A-8C show a method of mechanically connecting two charging modules according to some embodiments of the disclosure;

FIG. 9 shows an example of a battery charger with three interconnected charging modules according to an embodiment of the disclosure; and

FIG. 10 shows a schematic block diagram of the electrical system of a charging module according to an embodiment of the disclosure.

### DETAILED DESCRIPTION

The subject matter of the present disclosure is described with specificity herein to meet statutory requirements. However, the description itself is not intended to limit the scope of the technology. Rather, the claimed subject matter may be embodied in other ways, to include different elements, steps, and/or combinations of elements or steps, similar to the ones described in this disclosure, and in conjunction with other present or future technologies. Moreover, although the terms “step” and “block” may be used herein to connote different elements of various methods employed, the terms should not be interpreted as implying any particular order among or between various steps or blocks unless and except when the order of individual steps or blocks is explicitly described and required.

At a high level, the present disclosure relates generally to an implementation of several embodiments. One embodiment could implement full modularity and another embodiment could implement partial modularity.

Embodiments of the present disclosure may be embodied as, among other things, a method, a system, or an apparatus. Accordingly, the embodiments may take the form of a hardware embodiment, or an embodiment combining software and hardware. The present disclosure may take the form of a computer-program product that includes computer-useable instructions embodied on one or more computer-readable media. The present disclosure may further be implemented as being hard-coded into a mechanical design of scanning components, may be built into a scanner, and/or may be integrated into a scanning system including one or more computing or processing components.

Computer-readable media includes both volatile and non-volatile media, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media. Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

In an embodiment that implements full modularity, a single-slot device can include a printed circuit board (PCB) and upper and lower enclosures. The enclosures can be made from a variety of molded materials, including plastic. The upper and lower enclosures connect together to seal contents inside the enclosures. Inside the upper and lower enclosures, the PCB is located with male and female contacts on the sides of the PCB. The electronic hardware is designed so that two male contacts (e.g. pogo pins) and two female contacts (e.g. pads) are located on the four sides of the charger. In other embodiments, other connectors can be used for connecting the device and charging it. In some embodiments, mechanic centering features and a simple and quick joining system are implemented in the charger. For example, the joining system may include elements such as magnets, snap fit features formed in the housing, etc. The female or male contacts can act as a power supply input as will be described herein below.

With modularity of the space occupied by the modular charging station, a user can decide exactly where to position each single-slot charger (i.e. charging unit) and design a space to be occupied by the final modular charging station, according to space availability. The occupied space can be compact (e.g. with charging units arranged in a matrix) as opposed to the designs found in the prior art, which can only be placed in a line or linear fashion. A user has higher flexibility in choosing the position where to connect a single-slot charger to an external power supply, helping the user during the installation of the modular charging station, avoiding cable turns and entanglement.

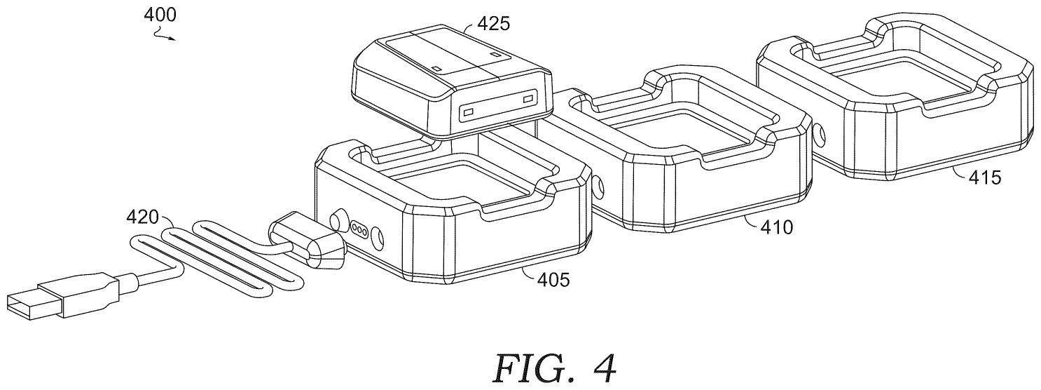

In another embodiment, the present disclosure can show an invention implemented in partial modularity. The single-slot charger can include a PCB with upper and lower enclosures. The electronic hardware may be designed so that the male contacts (e.g. pogo pins) and female contacts (e.g. pads) are located on two opposite sides of the charger, outside of the enclosures. As one will see in FIG. 4, the single-slot chargers may be laid out in a serial, linear, or horizontal configuration. Hence, the term partial modularity is used because the single-slot chargers have less flexibility in creating a configuration of chargers than the multi-battery charger with full modularity.

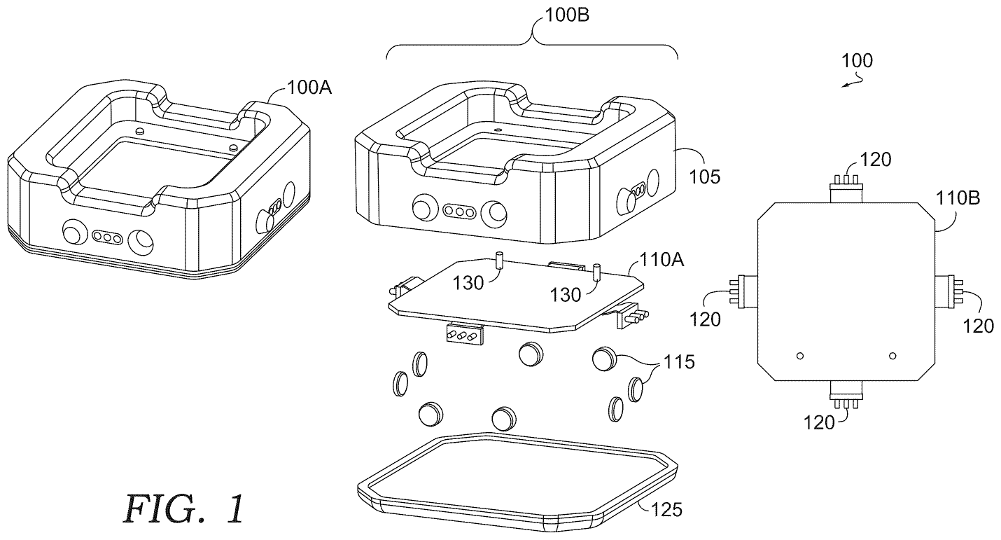

Referring to environment 100 of FIG. 1, a single-slot charger 100A is shown in a standalone configuration with all of its components intact. The same single-slot charger 100A is shown as a deconstructed charger 100B with an upper enclosure 105, PCB 110A, magnets 115, and lower enclosure 125. A rotated view of the PCB 110A is shown as PCB 110B. PCB 110B includes interfaces 120, which are located on each side of PCB 110B. PCB 110B includes hardware (pins 130) necessary for charging the device. In some embodiments, interfaces 120 may be configured to have a pair of male contacts (e.g. pogo pins) that are located opposite to each other while another pair may be female contacts (e.g. pads) that are located opposite to each other. In some embodiments, interfaces 120 may be configured to have a pair of male contacts located adjacent to each other on each corresponding side of PCB 110A and 110B while another pair of female contacts are located on the remaining adjacent sides of PCB 110A and 110B. These configurations are called full modularity.

In implementation of embodiments of the multi-battery charger, the matrix configuration is created even when the homologous connectors are located opposite to each other or when the homologous connectors are located adjacent to each other. It is only the spatial composition of the matrix that changes depending on where the male and female connectors are located. Either configuration provides for an efficient layout of the single-slot chargers, making the multi-battery charger as compact as possible.

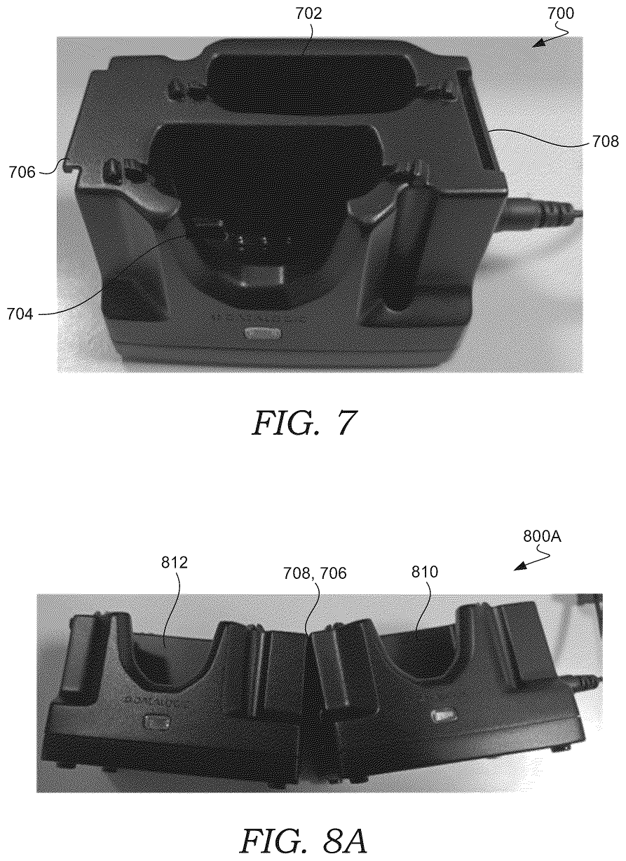

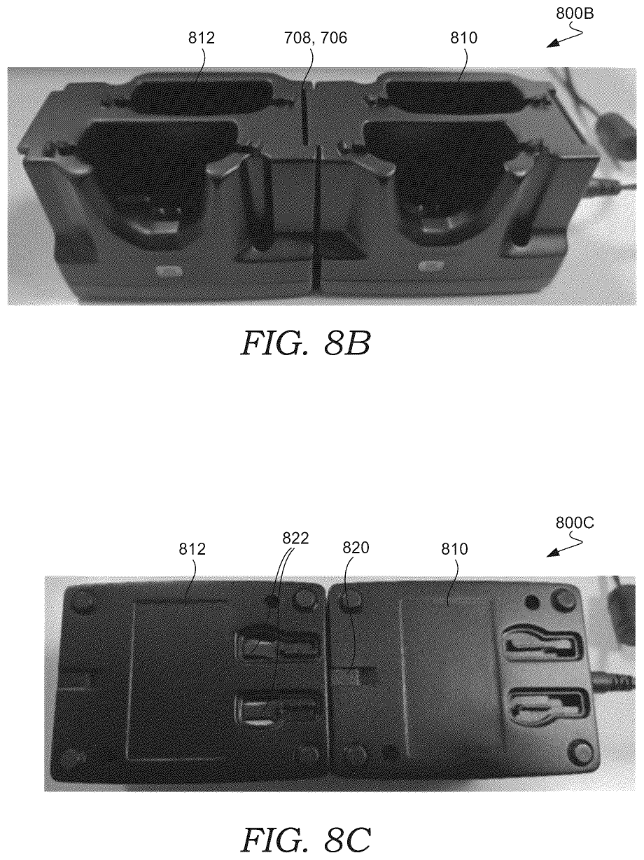

When the deconstructed charger 100B is assembled as the single-slot charger 100A, multiple versions of single-slot charger 100A can be connected together through a male contact connecting to a female contact. Two chargers can be held together at their male-female connection with magnets (e.g., magnets 115), a snap-fit connection or other mechanical connection (see FIGS. 8A-8C), or other systems (with or without a mechanical centering system) that allow a certain connection and give mechanical feedback to the user of the correct connection.

In other embodiments (not shown), interfaces 120 may be configured to exist only on two sides of the single-slot charger. In this configuration, one male contact is located on one side while one female contact is located on the opposite side. This configuration is called partial modularity.

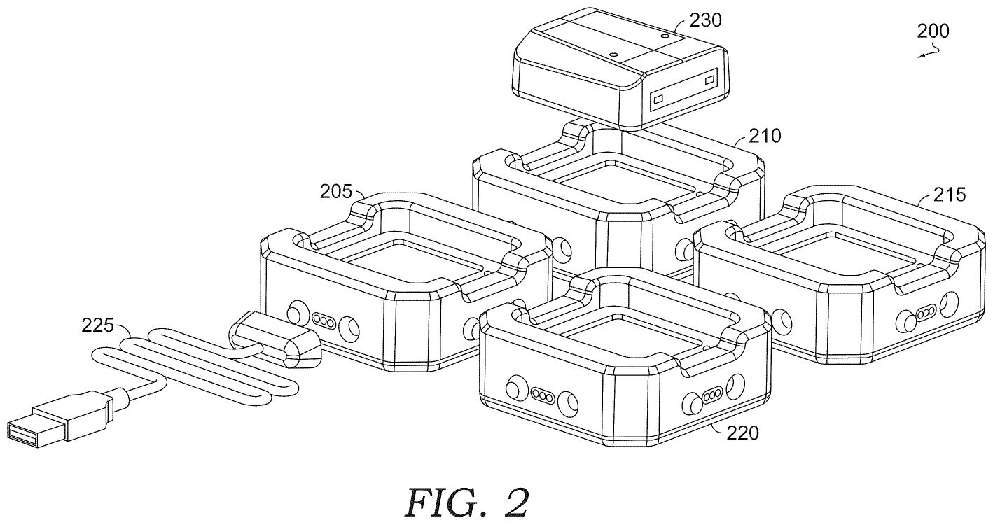

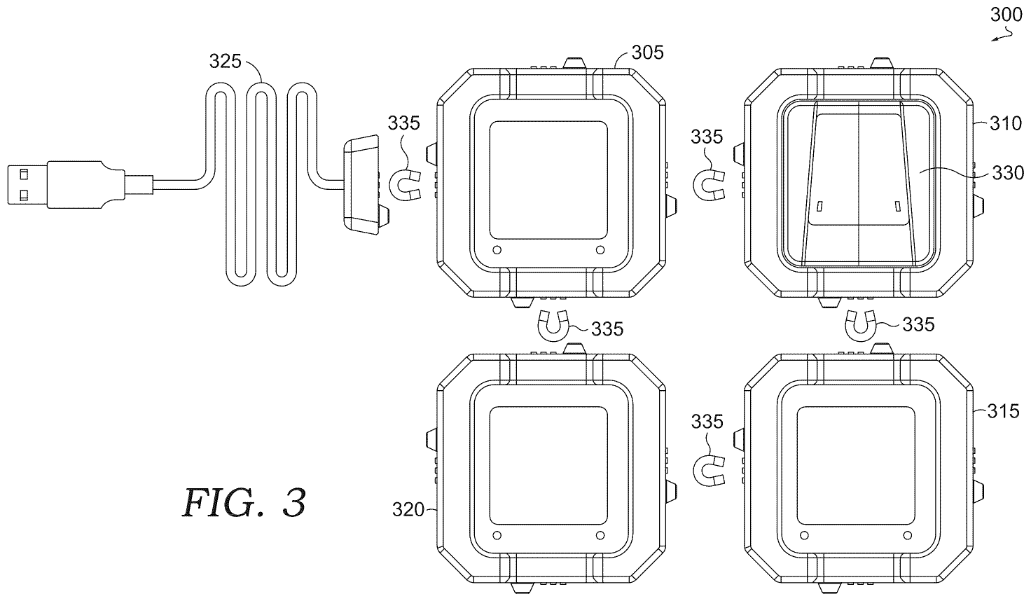

The design of the single-slot charger is made in such a way that it is possible to couple other single-slot chargers on all sides up to a desired number of charging stations, effectively transforming the single-slot charger into a multi-battery charger, as shown in FIGS. 2 and 3. The electronic connections between the individual slots are made through the connections by joining a male contact (e.g. pogo pins) with a female contact (e.g. pads). It is noted that the software with which each single-slot charger will be equipped may be able to recognize the connections of the additional single-slot chargers. One of the single-slot chargers can provide an interface for the power supply at one of the connectors to facilitate having the multi-battery charger.

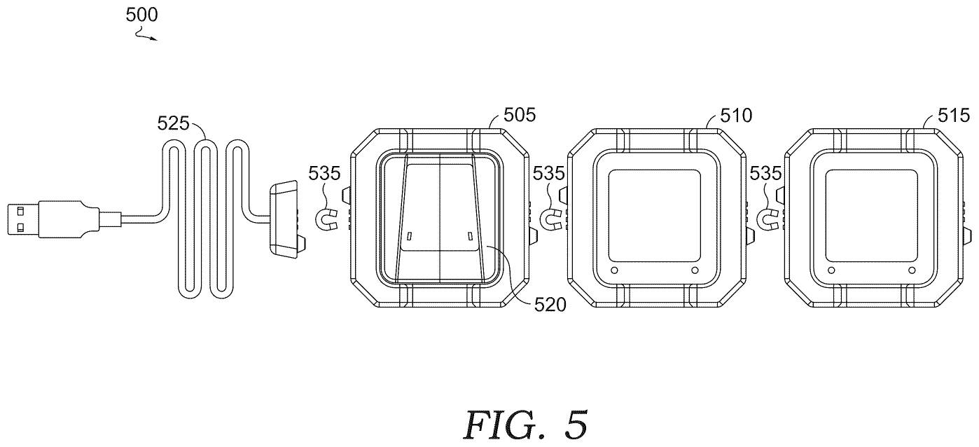

In FIG. 2, a multi-battery charger 200 is shown with single-slot chargers 205, 210, 215, and 220. As one can see, single-slot chargers 205, 210, 215, and 220 can be connected together at their interfaces as shown. However, in another embodiment, single-slot charges can be connected in a different configuration, such as a linear configuration shown in FIG. 5. As shown, a user could connect even more single-slot chargers together to create an even larger multi-battery charger. The number of single-slot chargers that can be connected together in the multi-battery charger may be limited by the amount of power that can be provided.

As shown in FIG. 2, one of the single-slot chargers (205) provides one of its interfaces as the power supply input 225. Although the power supply input 225 is shown as having a Universal Serial Bus (USB) connection, a user can implement another type of power supply input to meet their needs. For example, the power supply input could have an alternating current (AC) or direct current (DC) connector. The idea here is to illustrate that an external power supply can be provided to the multi-battery charger through the use of one of the single-slot chargers.

When the user wants to use the multi-battery charger, the user puts a battery 230 or similar device into a slot of the single-slot charger. As illustrated, battery 230 would be placed in single-slot charger 210 for charging. Additionally, several batteries could be charged simultaneously in the various available slots of the chargers. As stated earlier, if more slots are needed, additional single-slot chargers could be connected to the existing multi-battery charger.

It is noted that a number of single-slot chargers can be connected together, limited only by the amount of power that can be supplied to it. For example, whereas a power supply from a USB connection might limit the number of single-slot chargers that can be connected. If the power supply is changed to a larger input from an AC or DC connection, a larger number of single-slot chargers may be connected together.

Turning now to FIG. 3, a multi-battery charger 300 is shown in a top view illustrating full modularity using connections with magnets. In this embodiment, full modularity is a configuration where a single-slot charger can be connected from any one of its sides having a male contact to any one of the sides of one or more other single-slot chargers having a female contact. In other words, a male-female connection occurs between single-slot chargers. In FIGS. 2 and 3, the various single-slot chargers are connected together allowing for full modular connections to occur.

Multi-battery charger 300 has a configuration of single-slot chargers 305, 310, 315, and 320 connected together and held in place by magnets 335. And as discussed in an earlier figure, a power input 325 can connect to any one of the interfaces of a single-slot charger. In the case here, the power input 325 connects to an interface at single-slot charger 305.

A battery 330 is shown located in a slot of single-slot charger 310. Although the illustration shows a particular image of battery 330, another embodiment may include a battery 330 having a different shape or configuration. Likewise, the shape of the slot for a single-slot charger could be different as well. For example, in some embodiments the slot may be generally planar along a horizontal plane such that the battery (230, 330) rests horizontally when inserted into the slot as shown in FIGS. 2 through 5. In some embodiments, the slot may be generally planar in the vertical plane such that the battery may rest vertically when inserted into the slot as shown in FIG. 7 described below. Even further, although the current embodiment shows battery 330, another embodiment could be another type of device. For example, the single-slot charger could charge an operational device, such as a phone, a barcode scanner, etc. rather than a battery.

Up until now, the present disclosure has focused on the implementation of full modularity of the single-slot chargers giving rise to the configurations shown in FIGS. 2 and 3. However, the present disclosure provides for embodiments with partial modularity.

The design of the single-slot charger is made in such a way that it is possible to couple other single-slot chargers on two sides up to a desired number of charging stations, effectively transforming the single-slot charger into a multi-battery charger with partial modularity, as shown in FIGS. 4 and 5. The electronic connections between the individual slots are made through the connections by joining a male contact (e.g. pogo pins) with a female contact (e.g. pads). As discussed earlier for the multi-battery charger with full modularity, it is noted that the software with which each single-slot charger will be equipped may be able to recognize the connections of the additional single-slot chargers. One of the single-slot chargers can provide an interface for the power supply at one of the connectors to facilitate having the multi-battery charger with partial modularity.

In FIG. 4, a multi-battery charger 400 is shown with single-slot chargers 405, 410, and 415 arranged in a serial, horizontal or linear configuration. This arrangement of the single-slot chargers is achieved in the configuration of partial modularity because only two sides of single-slot chargers 405, 410, and 415 have interfaces. The opposite sides of single-slot chargers 405, 410, and 415 do not have interfaces. So, multi-battery charger 400 is limited in configuration although additional single-slot chargers can be added to the existing group.

A battery 425 can be inserted into single-slot charger 405 for charging. Additionally, a power supply 420 can connect to any one of the interfaces of single-slot chargers 405, 410, and 415 to provide power to multi-battery charger 400.

As discussed earlier for a multi-battery charger with full modularity, in FIG. 4, a number of single-slot chargers can be connected together, limited only by the amount of power that can be supplied to it. The number of single-slot chargers may be limited by a power supply from a USB connection versus a power supply from an AC or DC connection.

Turning now to FIG. 5, a multi-battery charger 500 is shown in a top view illustrating partial modularity using connections with magnets. In this embodiment, partial modularity is a configuration where a single-slot charger can be connected from any one of two sides to one of two sides of other single-slot chargers. In FIGS. 4 and 5, the various single-slot chargers are connected together allowing for partial modular connections to occur. Unlike full modularity where a matrix connection can be achieved with numerous single-slot chargers, partial modularity allows for a serial, horizontal, or linear connection of single-slot chargers.

Multi-battery charger 500 has a configuration of single-slot chargers 505, 510, and 515 connected together and held in place by magnets 535. And as discussed in an earlier figure, a power input 525 can connect to any one of the interfaces that exist on the two sides of a single-slot charger. In the case here, the power input 525 connects to an interface at single-slot charger 505.

A battery 520 is shown located in a slot of single-slot charger 505. Although the illustration shows a particular image of battery 520, another embodiment may include a battery 520 having a different shape or configuration. Likewise, as discussed earlier, the shape of the slot for a single-slot charger could be different as well. Even further, although the current embodiment shows battery 520, another embodiment could be another type of device. For example, the single-slot charger could charge an operational device, such as a phone, a gaming device, or a barcode reading device, rather than a standalone battery (that may be inserted into such devices). Barcode reading devices may include handheld scanners (e.g., pistol grip style scanners having a scan window), mobile computers that incorporate scan engines for barcode scanning, wearable scanners such as those that may be worn on a wrist, hand, finger, or the like.

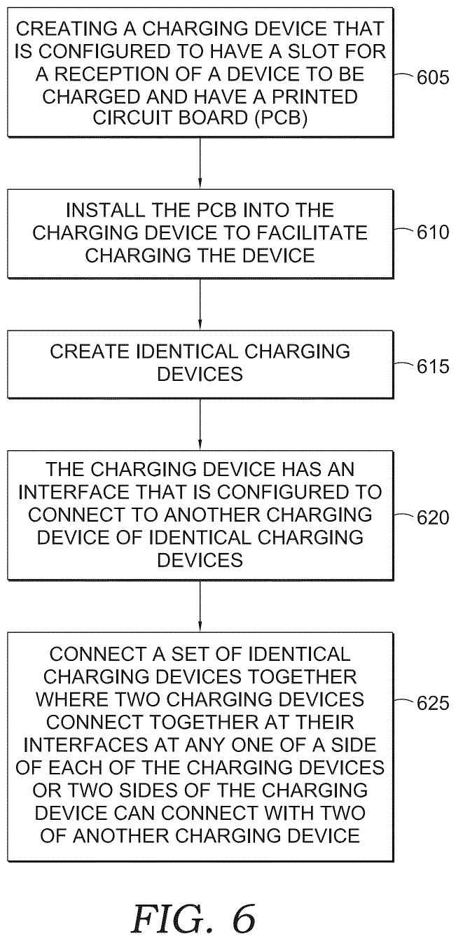

In FIG. 6, a method of making a multi-device charging station or multi-battery charger is provided in a process 600. Single-slot charger 100A is created and configured to have a slot for a reception of a device, such as a battery or a barcode reader that includes a battery, to be charged and have a printed circuit board (PCB) 110A, in a step 605. PCB 110A is installed into single-slot charger 100A to facilitate charging the device, in a step 610. In a step 615, identical single-slot chargers are created. In a step 620, single-slot charger 100A includes interface 120 that is configured to connect to another single-slot charger with interface 120. A set of identical single-slot chargers are connected together where two single-slot chargers connect together at their interfaces 120 at any one of a side of each of the single-slot chargers, in a step 625. Or, two sides of a single-slot charger can connect with only two sides on another single-slot charger, also in the step 625.

It is noted that every single-slot charger is identical and of the same type. Each single-slot charger could act as the power interface to the other single-slot chargers when connected together. This similar structure of single-slot chargers provides an advantage over chargers that have a master-slave configuration. Additionally, every single-slot charger can be connected or disconnected to another single-slot charger without requiring the mechanical addition or removal of components.

The multi-battery charger has the advantage of providing both a full modularity or partial modularity configuration. Additionally, each interface in the single-slot charger can act as a power supply input, which is an advantage over a charger with a fixed or predefined power interface. Also, connections between single-slot chargers can be held together with magnets or some type of magnetic connection. Using magnets or a magnetic interface removes the need to use mechanical connectors.

FIG. 7 shows a battery charger 700 for a battery and/or battery powered device according to another embodiment of the disclosure. The charging module 700 may include one or more charging slots 702, 704 for receiving a battery and/or a battery-powered electronic device (e.g., barcode reader) with a battery disposed therein. In some embodiments, one charging slot 702 may receive a battery-powered electronic device for charging its batter, and another charging slot 704 may receive a standalone battery that has been removed from a device for charging.

As with the examples provided in FIGS. 1-5, the charging module 700 may also be configured to engage mechanically and electrically with similarly configured charging modules to form a multi-battery charger comprising an interconnected set of modular battery chargers. The mechanical connections may be made via an interlocking connection between charging modules. For example, the battery charger 700 may include overhanging hook 706 on one end and a receptacle 708 on another end of the housing for connecting with other charging modules.

FIGS. 8A-8C include multi-battery charger views 800A-800C and show a method of mechanically connecting two charging modules 810, 812 according to some embodiments of the disclosure. This mechanical connection also facilitates an electrical connection between charging modules 810, 812. In FIG. 8A, the top ends of the charging modules may interlock by inserting the overhanging hook 706 of one charging module 810 into the receptacle 708 of another charging module 812. To better facilitate such engagement, the charging modules 810, 812 may be angled at the top to interlock at the hooked connection, after which the charging modules 810, 812 may rotate together to be side by side as shown in FIG. 8B. While in this position, the electrical connections may be made such that power may be flow therebetween. The electrical connection may be made through spring connections placed on the side of the charging modules 810, 812.

FIG. 8C shows the underside of the charging modules 810, 812, which may further include additional interlocking features to secure the charging modules 810, 812 at the bottom of the housings as well. A sliding mechanism 822 in one of the charging modules 812 may engage with a receptacle 820 of the other charging module 810 to make an interlocking connection at the bottom of the charging modules 810, 812. To release the charging modules 810, 812, the sliding mechanism 822 may be moved back from the receptacle 820 allowing the charging modules 810, 812 to rotate at the top to release the hooking mechanism.

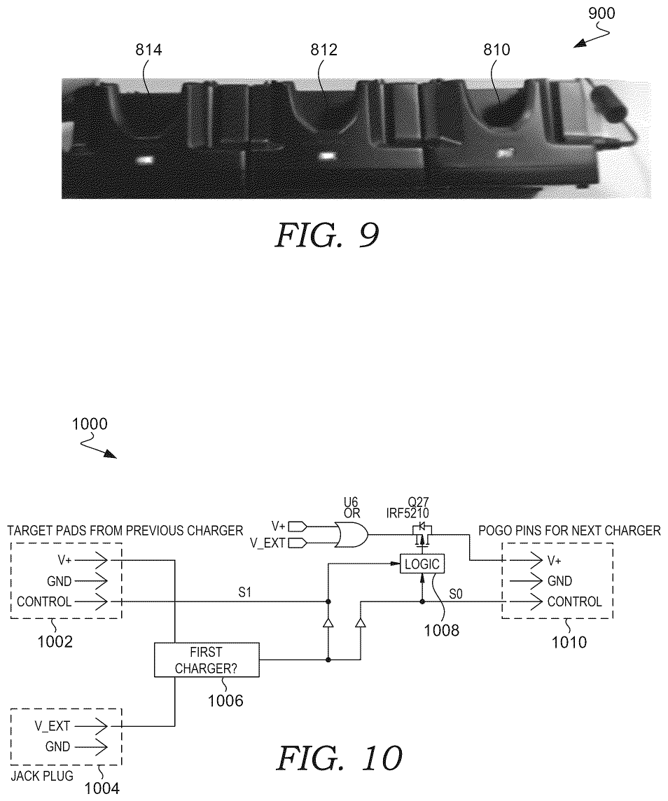

FIG. 9 shows an example of a battery charger 900 with three interconnected charging modules according 810, 812, 814 to an embodiment of the disclosure. These charging modules may be connected as described by FIGS. 8A-8C. Additional charging modules may also be further connected to the end of the third charging module 814 if desired.

For what concerns the electrical configuration, the internal circuits allows only a predetermined number (N) of charging modules to be supplied at the same time, to avoid overloading the power supply and the internal components. When the N+1 charging module is connected, this additional charging module may not be powered. This is done using control signals from one charging module in the electrical connections.

FIG. 10 shows a schematic block diagram of the electrical system 1000 of a charging module according to an embodiment of the disclosure. The charging module includes pads 1002 and a jack socket 1004 on one side of the charging module (e.g., the left side) as inputs to the charging module. The pads 1002 may connect with the outputs of another charging module, while the jack socket 1004 may connect with the external power source if the charging module is used as the first charging module of the group. The jack socket 1004 may not have any connections for the additional charging modules of the group as they will receive power through the pads 1002 instead.

The charging module further includes pogo pins 1010 or other output connectors on the other side of the charging module (e.g., the right side) as outputs to connect to another charging module if present. Thus, the jack socket 1004 may be used for the main power supply of the whole chain, while the target pads 1002 and pogo pins 1010 of adjacent charging modules match together to pass power and control from one charging module to the another. Considering the case of N=3, a minimum of 3 contacts may be provided between chargers: V+, GND, and 1× control signal.

The first charger is supplied from the jack 1004, while the target pads 1002 are floating. The first charger block 1006 detects the type of supply (target pads or jack), and, if it is determined to be the first charger (based on power supply from the jack), it forces the control signals “S1” and “S0” to a known active value (could be V+active high or GND active low). A logic block 1008 drives the MOSFET Q27 on based on the values of “SO” and “S1”.

The second charging module is supplied through the pogo pins from the first charging module. The first charger block 1006 in this case does not react and keeps the lines “SO” and “S1” untouched. This means that the signal “S1” is held active by the first charging module, while “SO” can go inactive, for example by means of a weak pull up or pull down. The logic block 1008 drives the MOSFET Q27 on based on the values of “SO” and “S1.”

The third charging module is supplied via the pogo pins from the second charging module. The first charger block 1006 of the third charging module does not react and keeps the lines “SO” and “S1” untouched. In this case both signals “SO” and “S1” are in the inactive state, since none of them are kept active from the first charging module. The logic block 1008 drives the MOSFET Q27 off, based on the values of “SO” and “S1.” In this way a fourth charging module will not be powered even if a fourth charger were to be connected to the end of the third charging module. This example is for a system that supports three charging modules; however, it is contemplated that some embodiments may support more charging modules. For embodiments that are able to support additional charging modules, additional control signals may be provided to operate in a similar fashion.

The present invention has been described in relation to particular embodiments, which are intended in all respects to be illustrative rather than restrictive. Many different arrangements of the various components depicted, as well as the use of components not shown, are possible without departing from the spirit and scope of the present disclosure. Alternative aspects will become apparent to those skilled in the art that do not depart from the scope. It will be understood that certain features and subcombinations are of utility and may be employed without reference to other features and subcombinations and are contemplated as within the scope of the claims.

What is claimed is:

1. A multi-battery charger, comprising:
at least two slot chargers configured to connect together at an interface where one slot charger has a male interface and the other slot charger has a female interface;
each of the at least two slot chargers includes an upper enclosure, a printed circuit board (PCB), a lower enclosure, and at least one male interface and one female interface that extend from the PCB;
wherein the upper enclosure is formed from a molded material and configured to hold a device that is to be charged;
wherein the PCB includes the at least one male interface and one female interface to enable contact with another slot charger; and
wherein the lower enclosure connects to the upper enclosure to enclose the PCB.

2. The multi-battery charger of claim 1, wherein the at least two slot chargers are identical and can connect other identical slot chargers to the multi-battery charger.

3. The multi-battery charger of claim 2, wherein the at least one male interface and one female interface are located opposite to each other, or the at least one male interface and one female interface are located adjacent to each other.

4. The multi-battery charger of claim 2, wherein two male interfaces are located on opposite sides of each of the at least two slot chargers and two female interfaces are located on the other opposite sides of each of the at least two slot chargers, or two male interfaces are located on adjacent sides of each of the at least two slot chargers and two female interfaces are located on the other adjacent sides of each of the at least two slot chargers.

5. The multi-battery charger of claim 1, further comprising an external power source that is configured to connect to the interface of the slot charger.

6. The multi-battery charger of claim 5, wherein the external power source supplies power to the multi-battery charger through the interface of the slot charger.

7. The multi-battery charger of claim 5, wherein the external power source is configured to connect to the interface with one of a USB connection, AC connection, or DC connection.

8. The multi-battery charger of claim 1, wherein the at least two slot chargers configured to connect together with magnets.

9. The multi-battery charger of claim 1, wherein the at least two slot chargers are configured to connect together at any one of a side of each of the at least two slot chargers allowing for full modularity.

10. The multi-battery charger of claim 1, wherein the at least two slot chargers are configured to connect together at any one of two sides of each of the at least two slot chargers allowing for partial modularity.

11. The multi-battery charger of claim 1, wherein the device is a battery.

12. The multi-battery charger of claim 1, wherein the PCB includes circuitry configured to communicate control signals between the at least two slot chargers to limit power to charging devices above a predetermined number supported by the multi-battery charger.

13. The multi-battery charger of claim 1, wherein the at least two slot chargers are configured to connect together with a hooking mechanism at a top portion of one of the at least two slot chargers being received by a receptacle at a top portion of the other of the at least two slot chargers, and a sliding mechanism at a bottom of a slot charger being received by another receptacle at a bottom portion of another slot charger.

14. A multi-battery charger, comprising:
two or more charging devices configured to have a slot for a reception of a battery to be charged and to have a printed circuit board (PCB) to enable charging;
the PCB is located in the two or more charging devices to facilitate charging the battery;
the PCB configured to have interfaces that extend from each of the two or more charging devices;
wherein the two or more charging devices are identical;
wherein an interface of the interfaces of the two or more charging devices is configured to connect to another interface of the interfaces of the two or more charging devices; and
the two or more charging devices connect together at their interfaces.

15. The multi-battery charger of claim 14, further comprising an external power source that is configured to connect to the interface of one of the two or more charging devices to supply power to the multi-battery charger.

16. The multi-battery charger of claim 15, wherein the external power source is configured to connect to the interface with one of a USB connection, AC connection, or DC connection.

17. The multi-battery charger of claim 14, wherein the slot of each of the two or more charging devices are configured to connect together at any one of a side of each of the two or more charging devices allowing for full modularity.

18. The multi-battery charger of claim 14, wherein the slot of each of the two or more charging devices are configured to connect together at any one of two sides of each of the two or more charging devices allowing for partial modularity.

19. A method of making a multi-battery charger, comprising:
creating a charging device that is configured to have a slot for a reception of a device to be charged and to have a printed circuit board (PCB) to enable charging;
installing the PCB into the charging device to facilitate charging the device;
implementing interfaces on the PCB that extend from the charging device;
wherein creating the charging device comprises creating a plurality of identical charging devices;
wherein an interface of the interfaces of the charging device is configured to connect to another interface of another charging device of the plurality of identical charging devices; and
connecting a set of the plurality of identical charging devices together where two charging devices connect together at their interfaces at one side of each of the two charging devices.

20. The method of claim 19, wherein connecting the set of the plurality of identical charging devices together comprises implementing a magnetic connection to connect each charging device to the another charging device.
